(19) United States
(12) Patent Application Publication
(10) Pub. No.: US 2017/0343891 A1
(43) Pub. Date: Nov. 30, 2017

(54) LIGHT SOURCE APPARATUS AND PROJECTOR

(71) Applicant: SEIKO EPSON CORPORATION, Tokyo (JP)

(72) Inventors: Hidefumi SAKATA, Tatsuno-Machi (JP); Koichi AKIYAMA, Matsumoto-Shi (JP)

(73) Assignee: SEIKO EPSON CORPORATION, Tokyo (JP)

(21) Appl. No.: 15/598,897

(22) Filed: May 18, 2017

(30) Foreign Application Priority Data
May 26, 2016 (JP) 2016-105354
Feb. 15, 2017 (JP) 2017-026320

(51) Int. Cl. G03B 21/20

(52) U.S. Cl. CPC G03B 21/206; G03B 21/2013; G03B 21/208

(57) ABSTRACT

A light source apparatus includes a first light source unit including a first light emitting device, a second light source unit including second and third light emitting devices, a light beam conversion system, and a light ray combiner. The first, second, and third light emitting devices emit first, second, and third light beams, respectively. The combiner has first, second, and third areas which these light beams enter, respectively. One of the light beams is a specific light beam. The direction in which the second and third areas are arranged is a third direction. The conversion system converts the specific light beam such that the dimension of the specific light beam in the third direction at a stage in which the specific light beam enters the combiner is smaller than that at a stage in which the specific light beam exits the conversion system.

### BACKGROUND

### 1. Technical Field

The present invention relates to a light source apparatus and a projector.

### 2. Related Art

As a light source apparatus used in a projector, for example, a light source apparatus using a laser device has been proposed. USP 2004/0252744 discloses a light source apparatus including two laser arrays each having a plurality of laser devices, a light combining element that combines light fluxes outputted from the two layer arrays with one another, and a collimator lens that parallelizes a light beam emitted from each of the laser devices. In the light source apparatus, the light combining element includes a substrate and a plurality of reflection films so provided on a surface of the substrate as to be separate from each other and extend in one direction. The light fluxes outputted from one of the laser arrays are reflected off the reflection films, and the light fluxes outputted from the other laser array pass through the spaces between the reflection films on the light combining element, whereby the light fluxes from the two laser arrays are combined with each other.

In the light combining element described above, the dimension of the reflection films and the dimension of the spaces in the direction in which the plurality of light beams are arranged are desirably greater than or equal to the diameter of the light beams. The reason for this is that loss of the light beams occurs in a case where the diameter of the light beams is greater than the dimension of the reflection films and the dimension of the spaces. That is, in the case where the diameter of the light beams is greater than the dimension of the reflection films, part of the light that is supposed to be reflected off the reflection films passes through the spaces and therefore does not travel in the direction in which the combined light flux exits. Further, in the case where the diameter of the light beams is greater than the dimension of the spaces, part of the light that is supposed to pass through the spaces is reflected off the reflection films and therefore does not travel in the direction which the combined light flux exits.

Unfortunately, to increase the dimension of the reflection films and the dimension of the spaces, the pitch of the arranged laser devices needs to be increased. Therefore, increasing the dimension of the reflection films and the dimension of the spaces in order to reduce the light loss undesirably increases the size of the laser arrays. In principle, arranging the collimator lenses in a position sufficiently close to the laser devices allows reduction in the diameter of the beams and hence reduction in the light loss. However, the closer the collimator lenses are positioned to the laser devices, the shorter the focal length of the collimator lenses needs to be. The shorter the focal length, the more the light loss is undesirably affected by misalignment of the laser devices. It is therefore difficult to dispose the collimator lenses in positions sufficiently close to the laser devices.

### SUMMARY

An advantage of some aspects of the invention is to provide a light source apparatus that allows reduction in light loss whereas controlling an increase in the size of a light source unit that includes a plurality of light emitting devices. Another advantage of some aspects of the invention is to provide a projector including the light source apparatus.

A light source apparatus according to an aspect of the invention includes a first light source unit for emitting a first light ray flux in a first direction, a second light source unit for emitting a second light ray flux in a second direction that interests the first direction, a first light beam conversion system, and a light ray combiner that is provided in a position downstream of the first light beam conversion system. The first light source unit includes a first light emitting device for emitting a first light beam. The first light ray flux contains the first light beam. The second light source unit including a second light emitting device for emitting a second light beam and a third light emitting device for emitting a third light beam. The second light ray flux contains the second light beam and the third light beam. The first light beam conversion system changes a dimension of a specific light beam that is one of the first light beam, the second light beam, and the third light beam. The light ray combiner reflects one of the first light ray flux and the second light ray flux to produce a combined light ray flux containing the first light ray flux and the second light ray flux. The light ray combiner has a second area on which the second light beam is incident, a third area on which the third light beam is incident, and a first area which is located between the second area and the third area and on which the first light beam is incident. The first light beam conversion system converts the specific light beam in such a way that a dimension of the specific light beam in a third direction, which is a direction in which the second area and the third area are arranged, at a stage in which the specific light beam enters the light ray combiner is smaller than the dimension of the specific light beam in the third direction at a stage in which the specific light beam exits the first light beam conversion system.

In the present specification, one of the first light beam, the second light beam, and the third light beam is the specific light beam. Since the light source apparatus according to the aspect of the invention includes the first light beam conversion system described above, the dimension of the specific light beam in the third direction at a stage in which the specific light beam enters the light ray combiner is smaller than that at a stage in which the specific light beam exits the first light beam conversion system. Therefore, even in a case where the pitch between the second light emitting device and the third light emitting device is small, loss of the specific light beam that occurs when the light ray combiner combines the first light ray flux and the second light ray flux with each other. A light source apparatus that allows reduction in light loss whereas controlling an increase in the size of at least the second light source unit can therefore be achieved.

In the light source apparatus according to the aspect of the invention, the third direction may be a direction between the first direction and the second direction in a plan view viewed in a direction perpendicular to the first direction and the second direction. The second light emitting device and the third light emitting device may be disposed in positions different from each other in the first direction. The first light beam conversion system may convert the specific light beam into a convergent light beam that converges in the plan view, and output the converted light. In the plan view, in the combined light ray flux, the first light beam may be positioned between the second light beam and the third light beam.

According to the configuration described above, a light source apparatus including the light ray combiner having the second area and the third area arranged in the direction between the direction in which the first light ray flux exits and the direction in which the second light ray flux exits can be provided, whereby a narrow combined light ray flux can be produced.

The light source apparatus according to the aspect of the invention may further include a second light beam conversion system that is provided on an optical path of the combined light ray flux and parallelizes the specific light beam in the plan view.

According to the configuration described above, the second light beam conversion system can parallelize the specific light beam in the plan view.

In the light source apparatus according to the aspect of the invention, each of the first light beam, the second light beam, and the third light beam may correspond to the specific light beam. When the first light beam, the second light beam, and the third light beam enter the second light beam conversion system, a dimension of the first light beam in a direction in which the second light beam and the third light beam are arranged may be smaller than a gap between the second light beam and the third light beam in the plan view.

According to the configuration described above, the first light beam, the second light beam, and the third light beam enter respective areas in the second light beam conversion system. The specific light beam can therefore be preferably parallelized.

In the light source apparatus according to the aspect of the invention, the first light source unit may include light emitting devices that include the first light emitting device and are disposed in positions different from one another in the second direction. The second light source unit may include light emitting devices that include the second light emitting device and the third light emitting device and are disposed in positions different from one another in the first direction. The light ray combiner may include reflective areas and light transmissive areas. The reflective areas and the light transmissive areas may be alternately disposed in the plan view.

According to the configuration described above, the light ray combiner can use the reflective areas and the light transmissive areas to readily combine the first light ray flux from the first light source unit including the light emitting devices with the second light ray flux from the second light source unit including the light emitting devices.

In the light source apparatus according to the aspect of the invention, the first light beam conversion system may include a first lens array having first lenses corresponding to light beams outputted from the first light source unit and a second lens array having second lenses corresponding to light beams outputted from the second light source unit. The second light beam conversion system may include a collimator lens array having collimator lenses. In the plan view, a pitch of the collimator lenses may be half a pitch of the light beams outputted from the first light source unit.

According to the configuration described above, each of the light beams outputted from the first light source unit is converted by the first lens array into a convergent light beam that converges in the plan view. Each of the light beams outputted from the second light source unit is converted by the second lens array into a convergent light beam that converges in the plan view. A light source apparatus that allows reduction in light loss whereas controlling an increase in the sizes of the first light source unit and the second light source unit can be achieved. Further, since the light beams enter respective collimator lenses, parallelized light can be produced with a small amount of light loss.

In the light source apparatus according to the aspect of the invention, each of the light emitting devices of the first light source unit may be formed of a laser diode having a light exiting area having a shorter side direction that intersects the second direction, and each of the light emitting devices of the second light source unit may be formed of a laser diode having a light exiting area having a shorter side direction that intersects the first direction.

According to the configuration described above, the light beam conversion system converts the light beam emitted from each of the light emitting devices into a convergent light beam that converges in a direction in which the divergence angle of the light beam is relatively small and outputs the converted light. The light beam conversion system may have small refractive power.

In the light source apparatus according to the aspect of the invention, the first light beam conversion system may cause the specific light beam to converge in the plan view but parallelize the specific light beam in a plane perpendicular to a plane containing the first direction and the second direction.

According to the configuration described above, the first light beam conversion system can convert the specific light beam into a convergent light beam parallelized in the plane perpendicular to the plane containing the first direction and the second direction. The dimension of the light ray combiner in the direction perpendicular to the first direction and the second direction can therefore be reduced.

In the light source apparatus according to the aspect of the invention, the third direction may be perpendicular to the first direction and the second direction. The first light emitting devices, the second light emitting device, and the third light emitting device may be disposed in positions different from one another in the third direction. In the combined light ray flux, the first light beam may be positioned between the second light beam and the third light beam when viewed in the first direction.

According to the configuration described above, a light source apparatus including the light ray combiner having the second area and the third area arranged in the direction perpendicular to the direction in which the first light ray flux exits and the direction in which the second light ray flux exits can be provided, whereby a narrow combined light ray flux can be produced.

In the light source apparatus according to the aspect of the invention, the first light source unit may include light emitting devices that include the first light emitting device and are disposed in positions different from one another in the third direction. The second light source unit may include light emitting devices that include the second light emitting device and the third light emitting device and are disposed in positions different from one another in the third direction. Light beams from the light emitting devices of the first light source unit and the light emitting devices of the second light source unit may each correspond to the specific light beam.

According to the configuration described above, the dimension of the light source apparatus in the third direction can be reduced.

The light source apparatus according to the aspect of the invention may further include a second light beam conversion system provided on an optical path of the combined light ray flux, and the second light beam conversion system may output the specific light beam as parallelized light when viewed in the first direction or the second direction.

According to the configuration described above, the second light beam conversion system can parallelize light that converges before entering the light ray combiner and diverges after exiting the light ray combiner. This can control light loss in an optical system downstream of the second light beam conversion system.

In the light source apparatus according to the aspect of the invention, the light emitting devices of the second light source unit may be so provided as to form a plurality of light source trains arranged in the third direction, and among the plurality of light source trains, the light source train including the second light emitting device may include a fourth light emitting device that is disposed in a position different from the second light emitting device in the first direction and emits a fourth light beam. In this case, the light ray combiner further has a fourth area on which the fourth light beam is incident. Further, the light ray combiner may be so provided as to receive the second light beam in a position where a dimension of the second light beam in the third direction is smallest among the dimensions thereof along an optical path of the second light beam between the first light beam conversion system and the second light beam conversion system and receive the fourth light beam in a position where a dimension of the fourth light beam in the third direction is smallest among the dimensions thereof along an optical path of the fourth light beam between the first light beam conversion system and the second light beam conversion system.

According to the configuration described above, each of the second light beam and the fourth light beam is incident on the light ray combiner in a position where the dimension of the light beam in the third direction is minimized, whereby light loss produced by the light ray combiner can be controlled.

In the light source apparatus according to the aspect of the invention, a distance between the second light emitting device and the light ray combiner along the second direction may be equal to a distance between the fourth light emitting device and the light ray combiner along the second direction.

According to the configuration described above, the first light beam conversion system can be readily designed.

In the light source apparatus according to the aspect of the invention, the first light beam conversion system may include an anamorphic lens on which the specific light beam is incident.

According to the configuration described above, the configuration of the first light beam conversion system can be simplified, and the specific light beam is allowed to converge in a specific direction.

In the light source apparatus according to the aspect of the invention, a divergence angle of the specific light beam in a plane perpendicular to the third direction may be greater than a divergence angle of the specific light beam in a plane containing a chief ray of the specific light beam and the third direction. The specific light beam may be emitted from a focal point of the anamorphic lens in the plane perpendicular to the third direction. The anamorphic lens may parallelize the specific light beam when viewed in the third direction.

According to the configuration described above, the dimension of the specific light beam in the third direction is reduced in the direction in which the divergence angle of the specific light beam is relatively small, whereby the dimension of the specific light beam in the third direction can be readily reduced, and light loss can therefore be reliably controlled.

The light source apparatus according to the aspect of the invention may further include a phosphor layer that converts at least part of the combined light ray flux into fluorescence.

According to the configuration described above, the color of the light outputted by the light source apparatus can be adjusted.

A projector according to another aspect of the invention includes the light source apparatus according to the aspect of the invention described above, a light modulator that modulates light outputted from the light source apparatus, in accordance with image information, and a projection system that projects the light modulated with the light modulator.

The projector according to the aspect of the invention includes the light source apparatus according to the aspect of the invention described above, whereby a compact projector that excels in light use efficiency can be achieved.

### BRIEF DESCRIPTION OF THE DRAWINGS

The invention will be described with reference to the accompanying drawings, wherein like numbers reference like elements.

FIG. 1 is a schematic configuration diagram of a projector according to a first embodiment.

FIG. 2 is a plan view of an illuminator of the first embodiment.

FIG. 3 is an enlarged view of key parts in FIG. 2.

FIG. 4 is a side view of light emitting devices and a light beam conversion system.

FIG. 5 is a perspective view of each of the light emitting devices.

FIG. 6 is a front view of a light ray combiner viewed in the direction of the arrow D shown in FIG. 2.

FIG. 7 is a plan view of an illuminator of a variation of the first embodiment.

FIG. 8 is an enlarged view of key parts in FIG. 7.

FIG. 9 is a plan view of an illuminator of a second embodiment.

FIG. 10 is a side view of light emitting devices and a light beam conversion system.

FIG. 11 is a plan view of key parts of a first light source apparatus of a third embodiment.

FIG. 12 is a perspective view of a light source apparatus of a fourth embodiment.

FIG. 13 is a plan view of the light source apparatus.

FIG. 14 is a side view of the light source apparatus viewed in a second direction.

FIG. 15 is a side view of the light source apparatus viewed in a first direction.

FIG. 16 is a front view showing a first example of the light ray combiner.

FIG. 17 is a front view showing a second example of the light ray combiner.

### DESCRIPTION OF EXEMPLARY EMBODIMENTS

### First Embodiment

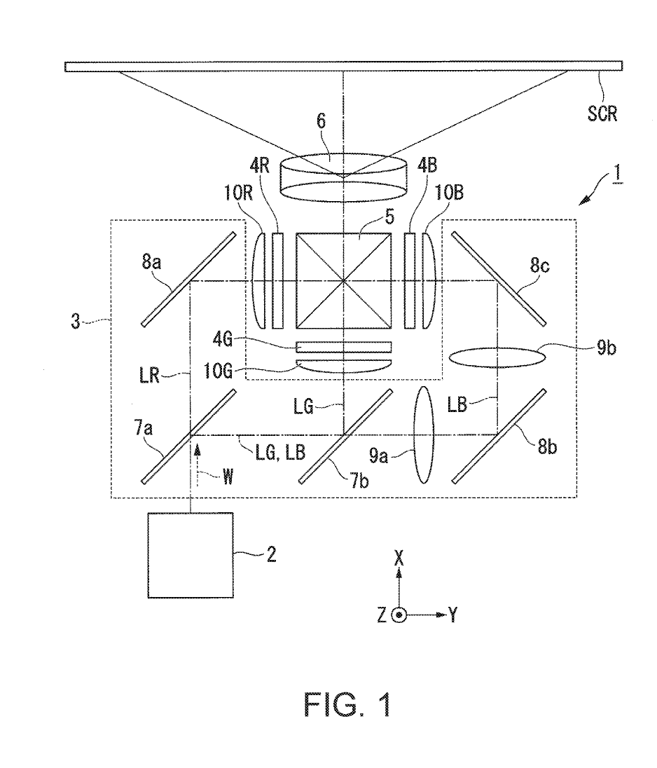

A projector according to a first embodiment will be described with reference to FIGS. 1 to 8.

The projector according to the present embodiment is a projection-type image display apparatus that displays color video images on a screen. The projector includes three liquid crystal light modulators corresponding to color light fluxes, red light, green light, and blue light. The projector includes laser diodes as a light source of an illuminator.

FIG. 1 is a schematic view showing an optical system of the projector according to the present embodiment.

A projector 1 includes an illuminator 2, a color separation system 3, light modulators 4R, 4G, and 4B, a light combining system 5, and a projection system 6, as shown in FIG. 1.

In the present embodiment, the illuminator 2 outputs illumination light in the form of white light W toward the color separation system 3.

The color separation system 3 separates the white light W into red light LR, green light LG, and blue light LB. The color separation system 3 includes a first dichroic mirror 7a and a second dichroic mirror 7b, a first total reflection mirror 8a, a second total reflection mirror 8b, and a third total reflection mirror 8c, and a first relay lens 9a and a second relay lens 9b.

The first dichroic mirror 7a transmits the red light LR but reflects the other light fluxes (green light LG and blue light LB). The second dichroic mirror 7b reflects the green light LG but transmits the blue light LB.

The first total reflection mirror 8a is disposed on the optical path of the red light LR and reflects the red light LR having passed through the first dichroic mirror 7a toward the light modulator 4R. The second total reflection mirror 8b and the third total reflection mirror 8c are disposed on the optical path of the blue light LB and guide the blue light LB having passed through the second dichroic mirror 7b toward the light modulator 4B. The green light LG is reflected off the second dichroic mirror 7b toward the light modulator 4G.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

Each of the light modulators 4R, 4G, and 4B is, for example, a transmissive liquid crystal panel. Polarizers (not shown) are disposed on the light incident side and the light exiting side of each of the liquid crystal panels.

Field lenses 10R, 10G, and 10B are disposed on the light incident side of the light modulators 4R, 4G, and 4B, respectively.

The light combining system 5 combines the image light fluxes corresponding to the red light LR, the green light LG, and the blue light LB with one another and outputs the combined image light toward the projection system 6. The light combining system 5 is, for example, a cross dichroic prism.

The projection system 6 is formed of a group of lenses. The projection system 6 enlarges and projects the combined image light from the light combining system 5 toward a screen SCR.

### Illuminator

The configuration of the illuminator 2 described above will next be described.

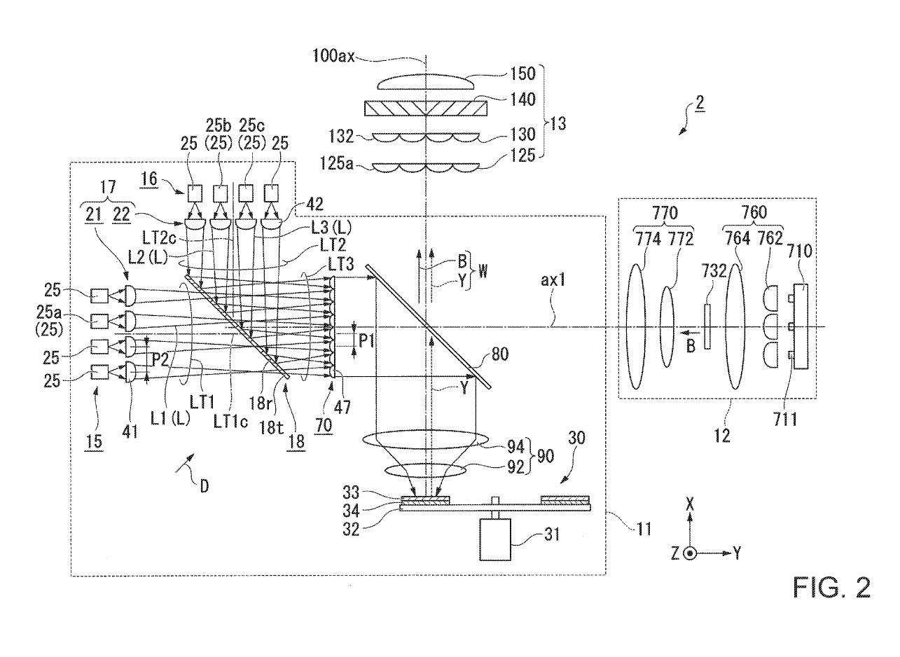

FIG. 2 shows a schematic configuration of the illuminator 2.

The illuminator 2 includes a first light source apparatus 11, a second light source apparatus 12, and a homogenizing illumination system 13, as shown in FIG. 2.

The first light source apparatus 11 in the first embodiment corresponds to the light source apparatus in the appended claims.

The following the description is made by using an XYZ orthogonal coordinate system in some cases in the drawings.

In FIG. 2, the direction parallel to an illumination optical axis 100ax of the illuminator 2 is the X-axis direction. The direction parallel to the optical axis ax1 of the first light source apparatus 11 is the Y-axis direction. The direction perpendicular to the X-axis direction and the Y-axis direction is the Z-axis direction.

The first light source apparatus 11 includes a first light source unit 15, a second light source unit 16, a first light beam conversion system 17, a light combiner 18, a first collimation system 70, a dichroic mirror 80, a first light collection system 90, and a rotating phosphor plate 30, as shown in FIG. 2. The first light beam conversion system 17 includes a first lens array 21 corresponding to the first light source unit 15 and a second lens array 22 corresponding to the second light source unit 16.

The first collimation system 70 in the present embodiment corresponding to the second light beam conversion system in the appended claims.

Each of the first light source unit 15 and the second light source unit 16 includes a plurality of light emitting devices 25. Each of the light emitting devices 25 is formed of a laser diode. Each of the light emitting devices 25 emits a blue light beam L having emitted light intensity with a peak at, for example, a wavelength of 445 nm.

The light emitting devices 25 of the first light source unit 15 include a first light emitting device 25a and are arranged in the X-axis direction (second direction). The light beam L emitted from the first light emitting device 25a is referred to as a first light beam L1. The first light source unit 15 outputs a first light ray flux LT1, which is formed of a plurality of light beams L including the first light beam L1, in the Y-axis direction (first direction).

The light emitting devices 25 of the second light source unit 16 include a second light emitting device 25b and a third light emitting device 25c disposed in positions different from each other in the Y-axis direction. The light emitting devices 25 are arranged in the Y-axis direction (first direction). The light beam L emitted from the second light emitting device 25b is referred to as a second light beam L2, and the light beam L emitted from the third light emitting device 25c is referred to as a third light beam L3. The second light source unit 16 outputs a second light ray flux LT2, which is formed of a plurality of light beams L including the second light beam L2 and the third light beam L3, in the X-axis direction (second direction).

As the second light emitting device 25b and the third light emitting device 25c, two light emitting devices 25 adjacent to each other are selected from four light emitting devices 25 of the second light source unit 16. In the present embodiment, it is assumed that the second light emitting device 25 counted from the left in FIG. 2 is the second light emitting device 25b and the third light emitting device 25 counted from the left in FIG. 2 is the third light emitting device 25c. As the first light emitting device 25a, the light emitting device 25 that emits a light beam L that enters the light ray combiner 18 in a position between the point of incidence of the second light beam L2 on the light ray combiner 18 and the point of incidence of the third light beam L3 on the light ray combiner 18 when viewed in the Z-axis direction. Therefore, in the present embodiment, the second light emitting device 25 counted from the top of four light emitting devices 25 of the first light source unit 15 is selected as the first light emitting device 25a.

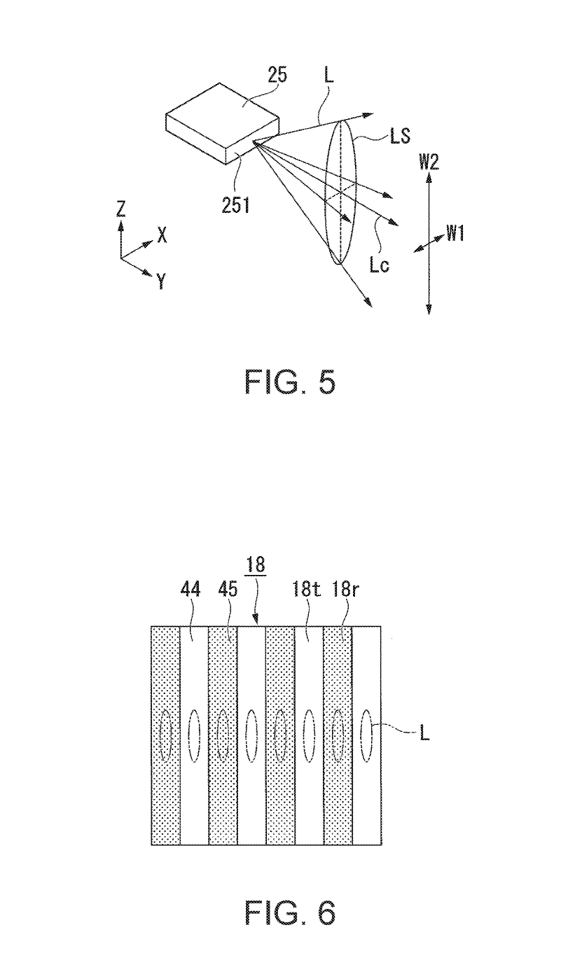

FIG. 5 is a perspective view of each of the light emitting devices 25.

The light emitting device 25 has a light exiting area 251, through which the light beam L exits, as shown in FIG. 5. The planar shape of the light exiting area 251 is a roughly rectangular shape having a longitudinal direction W1 and a shorter-side direction W2 when viewed in the direction of a chief ray Lc of the light beam L.

In the present embodiment, the width of light exiting area 251 in the longitudinal direction W1 is, for example, 40 μm. The width of light exiting area 251 in the shorter-side direction W2 is, for example, 1 μm. The shape and the dimensions of the light exiting area 251 are, however, not limited to those described above. In each of the light emitting devices 25 of the first light source unit 15, the longitudinal direction W1 of the light exiting area 251 coincides with the X-axis direction (second direction), and the shorter-side direction W2 of the light exiting area 251 coincides with the Z-axis direction, which intersects the X-axis direction. In each of the light emitting devices 25 of the second light source unit 16, the longitudinal direction W1 of the light exiting area 251 coincides with the Y-axis direction (first direction), and the shorter-side direction W2 of the light exiting area 251 coincides with the Z-axis direction, which intersects the Y-axis direction.

The light beam L emitted from each of the light emitting devices 25 is formed of linearly polarized light having a polarization direction parallel to the longitudinal direction W1 of the light exiting area 251. The divergence angle of the light beam L in the shorter-side direction W2 of the light exiting area 251 is greater than the divergence angle of the light beam L in the longitudinal direction W1 of the light exiting area 251. The cross-sectional shape LS of the light beam L is therefore an elliptical shape having a major-axis direction that coincides with the Z-axis direction (shorter-side direction W2).

FIG. 4 is a side view of the light emitting devices and the light beam conversion system of the first light source unit 15 viewed in the X-axis direction. The configuration of the second light source unit 16 is the same as the configuration of the first light source unit 15, and only the configuration of the first light source unit 15 is therefore illustrated in FIG. 4.

The first lens array 21 includes first lenses 41 corresponding to the respective light beams L outputted from the first light source unit 15. The first lenses 41 are arranged in the X-axis direction. Each of the first lenses 41 is formed of an anamorphic lens. The first lenses 41 cause the light beams L incident thereon to converge in the plane (XY plane) parallel to the direction in which the first lenses 41 are arranged (X-axis direction) and the direction of the chief rays of the light beams L (Y-axis direction). As shown in FIG. 4, the first lenses 41 parallelize the light beams L incident thereon in a plane (YZ plane) perpendicular to the XY plane.

The second lens array 22 includes second lenses 42 corresponding to the respective light beams L outputted from the second light source unit 16. The second lenses 42 are arranged in the Y-axis direction. Each of the second lenses 42 is formed of an anamorphic lens. The second lenses 42 cause the light beams L incident thereon to converge in the plane (XY plane) parallel to the direction in which the second lenses 42 are arranged (Y-axis direction) and the direction of the chief rays of the light beams L (X-axis direction). The second lenses 42 parallelize the light beams L incident thereon in a plane (XZ plane) perpendicular to the XY plane.

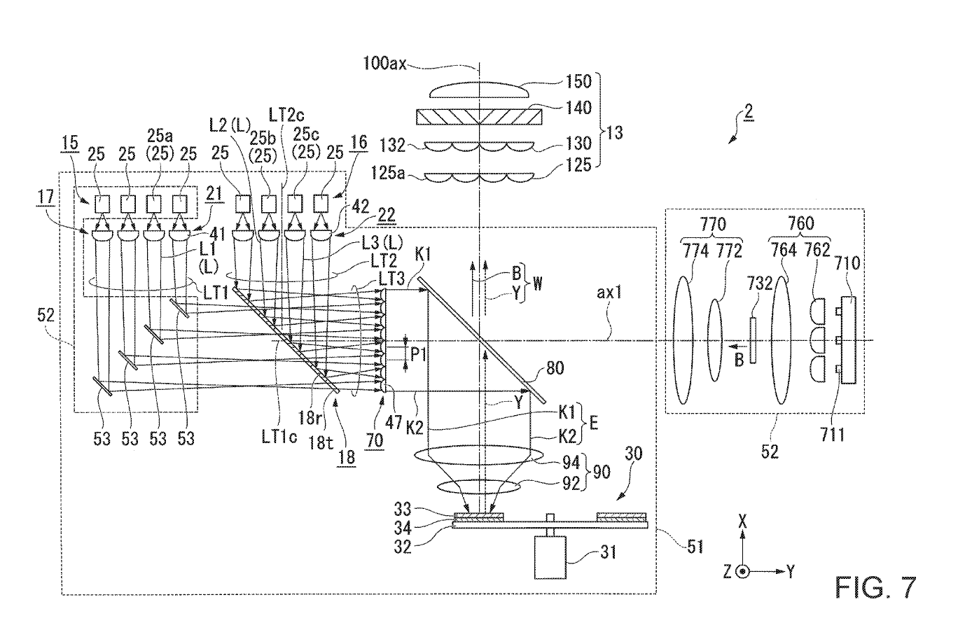

FIG. 6 is a front view of the light ray combiner 18 viewed in the direction of the arrow D shown in FIG. 2. The direction of the arrow D is the direction of a surface normal to the light ray combiner 18. FIG. 2 diagrammatically shows light beams L incident on the light ray combiner 18.

The light ray combiner 18 includes a substrate 44, which has optical transparency, and a plurality of reflection members 45, as shown in FIG. 6. The reflection members 45 are provided on one surface of the substrate 44 at predetermined intervals. Each of the reflection members 45 is configured by using a reflection film formed, for example, of a metal film or a dielectric multilayer film. On the one surface of the substrate 44, areas where the reflection members 45 are provided are reflective areas 18r, and areas where no reflection member 45 is provided are light transmissive areas 18t. That is, the light ray combiner 18 has a plurality of reflective areas 18r and a plurality of light transmissive areas 18t. In a plan view viewed in the Z-axis direction, the reflective areas 18r and the light transmissive areas 18t are alternately arranged. In the present specification, the plan view viewed in the Z-axis direction is simply referred to as a plan view.

The light ray combiner 18 is so disposed as to incline by 45° with respect to both the center axis LT1c of the first light ray flux LT1 outputted from the first light source unit 15 and the center axis LT2c of the second light ray flux LT2 outputted from the second light source unit 16, as shown in FIG. 2. That is, the light ray combiner is so disposed as to incline by 45° with respect to both the X and Y axes.

When the light ray combiner 18 is viewed in the direction of a surface normal to the substrate 44, each of the reflective area 18r and the light transmissive area 18t has an oblong shape having a longitudinal direction that coincides with the Z-axis direction and a shorter-side direction that coincides with the direction inclining by 45° with respect to the X axis and the Y axis in the XY plane, as shown in FIG. 6. The first light source unit 15 and the light ray combiner 18 are so disposed that the light beams L emitted from the light emitting devices 25 of the first light source unit 15 are incident on the respective light transmissive areas 18t. The second light source unit 16 and the light ray combiner 18 are so disposed that the light beams L emitted from the light emitting devices 25 of the second light source unit 16 are incident on the respective reflective areas 18r. The light ray combiner 18 transmits the first light ray flux LT1 whereas reflecting the second light ray flux LT2, thereby producing a combined light ray flux LT3 containing the first light ray flux LT1 and the second light ray flux LT2.

How the first light beam conversion system 17 causes the light beams L incident thereon to converge will now be described in more detail.

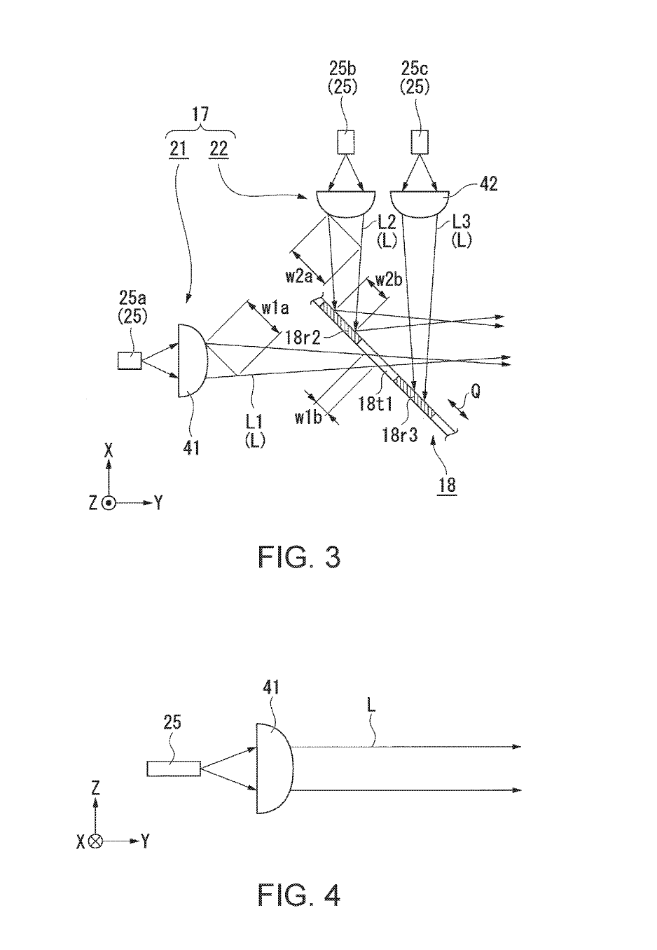

FIG. 3 is an enlarged view of key parts in FIG. 2.

In the light ray combiner 18, the reflective area 18r on which the second light beam L2 is incident is called a second area 18r2, and the reflective area 18r on which the third light beam L3 is incident is called a third area 18r3. The light transmissive area 18t which is located between the second area 18r2 and the third area 18r3 and on which the first light beam L1 is incident is called a first area 18t1. Further, the direction in which the second area 18r2 and the third area 18r3 are arranged is called a third direction Q. Under the definition described above, the third direction Q inclines by 45° with respect to both the X-axis direction (second direction) and the Y-axis direction (first direction).

In the present embodiment, each of the first light beam L1, the second light beam L2, and the third light beam L3 corresponds to a specific light beam.

The first lens 41 converts the first light beam L1 into a convergent light beam that converges in the plan view, as shown in FIG. 3. The diameter of the first light beam L1 in the X-axis direction at a first stage in which the first light beam L1 enters the light ray combiner 18 is therefore smaller than the diameter of the first light beam L1 in the X-axis direction at a second stage in which the first light beam L1 exits the first light beam conversion system 17. In other words, the first lens 41 converts the first light beam L1 into the convergent light beam, which converges in the plan view, in such a way that the dimension w1b of the first light beam L1 in the third direction Q at the first stage is smaller than the dimension w1a of the first light beam L1 in the third direction Q at the second stage, and outputs the converted light beam. In the following description, the term “convergent light beam” refers to a light beam that converges at least in the plan view.

The second lens 42 converts the second light beam L2 into a convergent light beam. The diameter of the second light beam L2 in the Y-axis direction at a third stage in which the second light beam L2 enters the light ray combiner 18 is therefore smaller than the diameter of the second light beam L2 in the Y-axis direction at a fourth stage in which the second light beam L2 exits the first light beam conversion system 17. In other words, the second lens 42 converts the second light beam L2 into the convergent light beam in such a way that the dimension w2b of the second light beam L2 in the third direction Q at the third stage is smaller than the dimension w2a of the second light beam L2 in the third direction Q at the fourth stage, and outputs the converted light beam.

The third beam L3 is converted into a convergent light beam by the corresponding second lens 42, as the second light beam L2 is.

As described above, the first light beam conversion system 17 converts each of the specific light beams into a convergent light beam in such a way that the dimension of the specific light beam in the third direction Q at a stage in which the specific light beam enters the light ray combiner 18 is smaller than the dimension of the specific light beam in the third direction Q at a stage in which the specific light beam exits the first light beam conversion system 17, and outputs the converted light beam.

The first collimation system 70 is provided in a position downstream of the light ray combiner 18, as shown in FIG. 2. The first collimation system 70 parallelizes, in the plan view, the specific light beams having exited out of the first light beam conversion system 17. The first collimation system 70 includes a collimator lens array having a plurality of collimator lenses 47. In the plan view, the pitch P1 of the plurality of collimator lenses 47 is half a pitch P2 of the plurality of the light beams L outputted from the first light source unit 15.

When the first light beam L1, the second light beam L2, and the third light beam L3 enter the first collimation system 70, the dimension of the first light beam L1 in the direction in which the second light beam L2 and the third light beam L3 are arranged (X-axis direction) in the plan view is smaller than the gap between the second light beam L2 and the third light beam L3.

The rotating phosphor plate 30 has an annular phosphor layer 33 on a substrate 32 rotatable with a motor 31. The substrate 32 is formed of a metal plate that excels in heat dissipation, for example, a plate made of aluminum or copper.

The phosphor layer 33 is excited by blue excitation light E and emits fluorescence Y containing red light and green light. The phosphor layer 33, for example, contains (Y,Gd)₃(Al,Ga)₅O₁₂:Ce, which is a YAG-based phosphor.

A dielectric multilayer film 34 is provided between the phosphor layer 33 and the substrate 32. The dielectric multilayer film 34 reflects most of the fluorescence Y incident thereon toward the side opposite the substrate 32. That is, the rotating phosphor plate 30 outputs the fluorescence Y toward the same side on which the excitation light E is incident.

The combined light ray flux LT3, which is formed of the first light ray flux LT1 and the second light ray flux LT2, exits the first collimation system 70. The combined light ray flux LT3 is incident on the dichroic mirror 80. The combined light ray flux LT3 forms the excitation light E.

In the present embodiment, the dichroic mirror 80 is so disposed on the light path from the first collimation system 70 to the first light collection system 90 as to intersect at 450 both the optical axis ax1 of the first light source apparatus 11 and the illumination optical axis 100ax of the illuminator 2. The dichroic mirror 80 reflects the excitation light E toward the first light collection system 90.

The first light collection system 90 collects the excitation light E toward the phosphor layer 33 of the rotating phosphor plate 30 and roughly parallelizes the fluorescence Y emitted from the rotating phosphor plate 30. The first light collection system 90 includes a first convex lens 92 and a second convex lens 94.

The second light source apparatus 12 includes a second light source 710, a second light collection system 760, a scattering plate 732, and a second collimation system 770.

The second light source 710 includes a plurality of light emitting devices 711. Each of the plurality of light emitting devices 711 is formed of a laser diode. Each of the light emitting devices 711 emits a blue light beam having emitted light intensity that peaks, for example, at the wavelength of 445 nm, but the intensity peak wavelength is not limited to 445 nm.

The second light collection system 760 includes first convex lenses 762 and a second convex lens 764. The second light collection system 760 collects the blue light fluxes B outputted from the second light source 710 in positions in the vicinity of the scattering plate 732.

The scattering plate 732 scatters the blue light fluxes B outputted from the second light source 710 to impart a light orientation distribution similar to the light orientation distribution of the fluorescence Y emitted from the rotating phosphor plate 30 to the blue light B. The scattering plate 732 can, for example, be a ground glass plate made of optical glass.

The second collimation system 770 includes a first convex lens 772 and a second convex lens 774. The second collimation system 770 roughly parallelizes the blue light fluxes B having exited out of the scattering plate 732.

The blue light fluxes B outputted from the second light source apparatus 12 is reflected off the dichroic mirror 80 and combined with the fluorescence Y having been emitted from the rotating phosphor plate 30 and having passed through the dichroic mirror 80 to form the white light W. The white light W is incident on the homogenizing illumination system 13.

The homogenizing illumination system 13 includes a first lens array 125, a second lens array 130, a polarization conversion element 140, and a superimposing lens 150.

The first lens array 125 has a plurality of first lenslets 125a, which divide the white light W having exited out of the dichroic mirror 80 into a plurality of sub-light fluxes. The plurality of first lenslets 125a is arranged in a matrix in a plane perpendicular to the illumination optical axis 100ax.

The second lens array 130 has a plurality of second lenslets 132 corresponding to the plurality of first lenslets 125a of the first lens array 125. The second lens array 130, along with the superimposing lens 150, forms images of the first lenslets 125a of the first lens array 125 in the vicinity of an image formation area of each of the light modulators 4R, 4G, and 4B. The plurality of second lenslets 132 are arranged in a matrix in a plane perpendicular to the illumination optical axis 100ax.

The polarization conversion element 140 aligns the polarization directions of the white light W with one another. The polarization conversion element 140 is formed, for example, of a polarization separation film, a retardation film, and a mirror. The polarization conversion element 140 converts the fluorescence Y, which is non-polarized light, into linearly polarized light.

The superimposing lens 150 collects the sub-light fluxes having exited out of the polarization conversion element 140 and superimposes the collected sub-light fluxes on one another in the vicinity of the image formation area of each of the light modulators 4R, 4G, and 4B. The first lens array 125, the second lens array 130, and the superimposing lens 150 form an optical integration system that homogenizes the in-plane light intensity distribution of the white light W in each of the image formation areas.

In a light source apparatus of related art, in which light beams parallelized by collimator lenses enter a light ray combiner, the diameter of each light beam incident on the light ray combiner is roughly equal to the diameter of the light beam having exited the collimator lenses. Therefore, reducing the pitch of a plurality of arranged light emitting devices in order to reduce the size of the light source apparatus causes blocking or vignetting of light in the light ray combiner, undesirably resulting in light loss.

In contrast, the first light source apparatus 11 of the present embodiment includes the first light beam conversion system 17, which includes the first lens array 21 and the second lens array 22. The first lens array 21 causes the plurality of light beams L outputted from the first light source unit 15 to converge in the XY plane. Further, the second lens array 22 causes the plurality of light beams L outputted from the second light source unit 16 to converge in the XY plane. The diameter of the first light beam L1 in the X-axis direction at the first stage is smaller than the diameter of the first light beam L1 in the X-axis direction at the second stage, as described above. Further, the diameter of the second light beam L2 in the Y-axis direction at the third stage is smaller than the diameter of the second light beam L2 in the Y-axis direction at the fourth stage.

Therefore, reducing the pitch of the plurality of arranged light emitting devices 25 is unlikely to result in the blocking of light, whereby the amount of light loss can be reduced. Further, reducing the pitch of the plurality of arranged light emitting devices 25 allows reduction in the sizes of the first light source unit 15, the second light source unit 16, and the light ray combiner 18, whereby the size of the first light source apparatus 11 can be reduced.

Further, in the first light source apparatus 11 of the first embodiment, in which the first light ray flux LT1 from the first light source unit 15 and the second light flux LT2 from the second light source unit 16 are combined with each other, the intensity of the light from the first light source apparatus 11 can be increased. Further, since the light ray combiner 18 uses no polarization separation element, the polarization direction of the first light ray flux LT1 and the polarization direction of the second light ray flux LT2 are allowed to coincide with each other. This situation can reduce influence on the optical characteristics of the optical system downstream of the first light source apparatus 11. The influence includes difference in brightness and difference in color that may be caused by difference in polarization direction.

The first collimation system 70 provided in the first light source apparatus 11 of the present embodiment can convert each specific light beam into parallelized light, which light beam has been converted into a convergent light beam.

In the first light source apparatus 11 in the present embodiment, when the first light beam L1, the second light beam L2, and the third light beam L3 enter the first collimation system 70, the dimension of the first light beam L1 in the direction in which the second light beam L2 and the third light beam L3 are arranged in the plan view is smaller than the gap between the second light beam L2 and the third light beam L3. Therefore, since each of the light beams enters the corresponding collimator lens 47, whereby a decrease in light use efficiency can be reduced.

In the first light source apparatus 11 of the present embodiment, the first light source unit 15 includes the plurality of light emitting devices 25 arranged in the X-axis direction, the second light source unit 16 includes the plurality of light emitting devices 25 arranged in the Y-axis direction, and the light ray combiner 18 has the reflective areas 18r and the light transmissive areas 18t alternately disposed in the plan view. The light ray combiner 18 can therefore readily combine the first light ray flux LT1 and the second light ray flux LT2 with each other.

In the first light source apparatus 11 of the present embodiment, each of the light emitting devices 25 provided in the first light source unit 15 is formed of a laser diode having the light exiting area 251 having a shorter-side direction that intersects the X-axis direction, and each of the light emitting devices 25 provided in the second light source unit 16 is formed of a laser diode having the light exiting area 251 having a shorter-side direction that intersects the Y-axis direction. The longitudinal direction of the cross section of the light beam L emitted from each of the light emitting devices 25 coincides with the longitudinal direction (Z-axis direction) of the corresponding reflective area 18r or light transmissive area 18t. The shorter-side direction of the cross section of the light beam L emitted from each of the light emitting devices coincides with the shorter-side direction of the corresponding reflective area 18r or light transmissive area 18t. In other words, the shorter-side direction of the cross section of each of the light beams L is parallel to the XY plane. Therefore, as compared with a case where the shorter-side direction of the cross section of each of the light beams L coincides with the longitudinal direction of the corresponding reflective area 18r or light transmissive area 18t, the first light beam conversion system 17 may have small refractive power.

In the first light source apparatus 11 of the present embodiment, the first light beam conversion system 17 is formed of anamorphic lenses each of which parallelizes light in the Z-axis direction. The dimension of the light ray combiner 18 in the Z-axis direction can therefore be reduced.

### Variation of First Embodiment

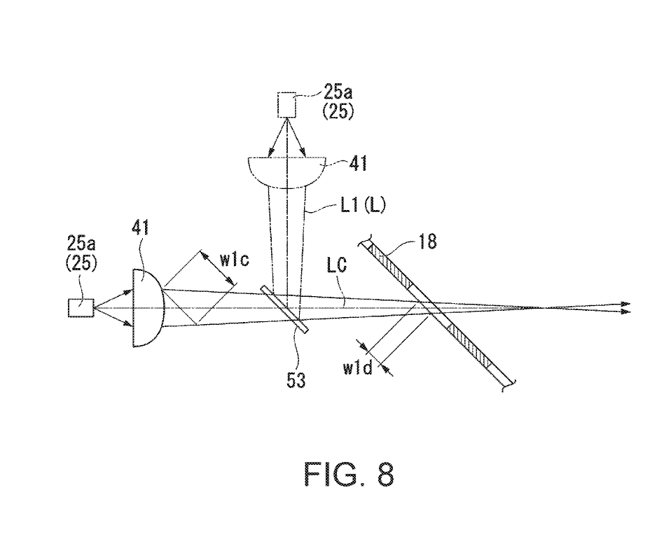

A variation of the first embodiment will be described below with reference to FIGS. 7 and 8.

The basic configuration of the illuminator of the present variation is the same as that in the first embodiment, but the configuration of the first light source unit of the first light source apparatus differs from that in the first embodiment. The overall first light source apparatus will therefore not be described, and only the first light source unit will be described.

FIG. 7 is a plan view of the illuminator of the variation of the first embodiment. FIG. 8 is an enlarged view of key parts in FIG. 7.

In FIGS. 7 and 8, the same components as those in the drawings used in the first embodiment have the same reference characters and will not be described.

In a first light source apparatus 51 of the present variation, a first light source unit 52 includes the plurality of light emitting devices 25 including the first light emitting device 25a, which emits the first light beam L1, and a plurality of mirrors 53, as shown in FIG. 7. The mirrors 53 are provided on the optical paths of the respective light beams L emitted from the light emitting devices 25. The mirrors 53 deflect the optical paths of the light beams L emitted from the light emitting devices 25 by 90° and guide the light beams L to the light ray combiner 18.

In the present variation, the plurality of light emitting devices 25 that forms the first light source unit 52 is provided in a position adjacent to the plurality of light emitting devices 25 that forms the second light source unit 16. All the light emitting devices 25 that form the first light source unit 52 and the second light source unit 16 emit light beams L in the second direction (X-axis direction).

The mirrors are so provided as to incline by 45° with respect to the first direction (Y-axis direction) and the second direction (X-axis direction). Therefore, the light beams L exit the light emitting devices 25 of the first light source unit 52 in the second direction (X-axis direction), then reflect off the mirrors 53, travel in the first direction (Y-axis direction), and enter the light ray combiner 18. In the embodiment described above, the optical paths of the light beams L from the plurality of light emitting devices 25 to the light ray combiner 18 linearly extend, whereas in the present variation, the optical paths of the light beams L from the plurality of light emitting devices 25 to the light ray combiner 18 are deflected by 90°. The angle by which the optical paths of the light beams L are deflected is not necessarily 90°.

Also in the present variation, the first light beam conversion system 17 converts each of the specific light beams into a convergent light beam in such a way that the dimension of the specific light beam in the third direction at a stage in which the specific light beam enters the light ray combiner 18 is smaller than the dimension of the specific light beam in the third direction at a stage in which the specific light beam exits the first light beam conversion system 17.

It is, however, noted that in the case where the optical paths from the plurality of light emitting devices 25 to the light ray combiner 18 are deflected, as in the present variation, the dimension in the third direction is defined as follows.

FIG. 8 is an enlarged view of the optical path from the single light emitting device 25a in FIG. 7 to the light ray combiner 18.

In the case where the light beam L emitted from the light emitting device 25a is deflected, an imaginary arrangement in which a chief ray LC of the light beam L emitted from the light emitting device 25a linearly extends is considered, as shown in FIG. 8. In the imaginary arrangement, the first lens 41 converts the first light beam L1 into a convergent light beam in such a way that the dimension w1d of the first light beam L1 in the third direction at a stage in which the first light beam L1 enters the light ray combiner 18 is smaller than the dimension w1c of the first light beam L1 in the third direction at a stage in which the first light beam L1 exits the first lens 41. The same holds true for a case where the light beam L is deflected at an angle different from 90°.

The present variation also provides the same advantageous effect of the first embodiment, that is, a first light source apparatus 51 that allows reduction in light loss while controlling an increase in the size of the apparatus can be achieved.

### Second Embodiment

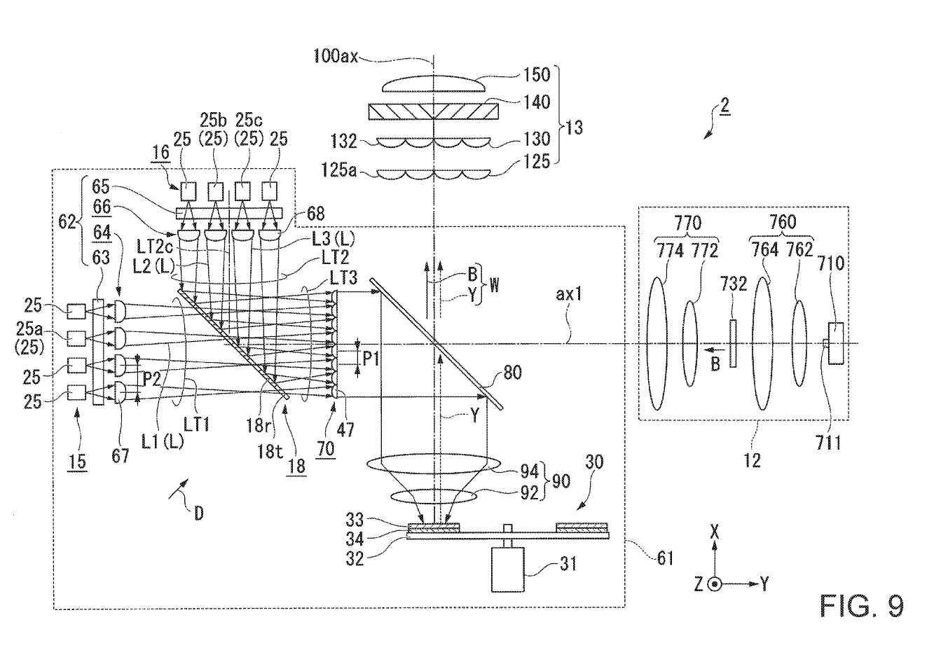

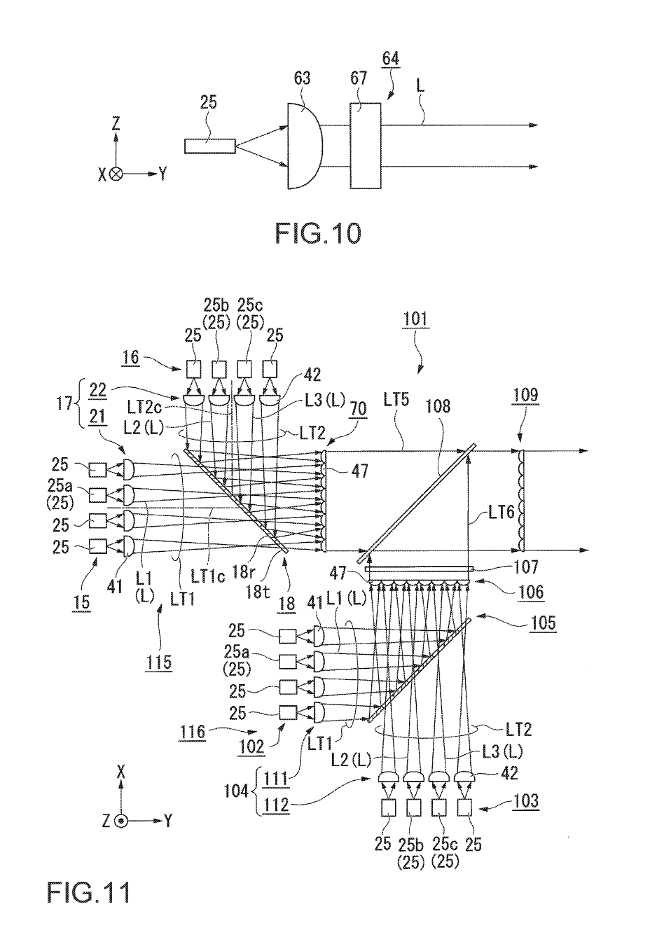

A second embodiment of the invention will be described below with reference to FIGS. 9 and 10.

The basic configuration of the light source apparatus of the second embodiment is the same as that in the first embodiment, but the configuration of the light beam conversion system differs from that in the first embodiment. The overall light source apparatus will therefore not be described, and only the light beam conversion system will be described.

FIG. 9 is a plan view of an illuminator of the second embodiment. FIG. 10 is a side view of the light emitting devices and the light beam conversion system.

In FIGS. 9 and 10, the same components as those in the drawings used in the first embodiment have the same reference characters and will not be described.

Also in the second embodiment, a first light source apparatus 61 corresponds to the light source apparatus in the appended claims, as in the first embodiment.

A light beam conversion system 62 provided in the first light source apparatus 61 includes a first cylindrical lens 63 and a first lens array 64, which correspond to the first light source unit 15, and a second cylindrical lens 65 and a second lens array 66, which correspond to the second light source unit 16, as shown in FIG. 9.

The first cylindrical lens 63 is so provided as to be common to the plurality of light emitting devices 25 that form the first light source unit 15. The plurality of light beams L emitted from the plurality of light emitting devices 25 enters the first cylindrical lens 63. The first cylindrical lens 63 has no curvature in the plan view. The first cylindrical lens 63 has curvature in the side view viewed in the X-axis direction, as shown in FIG. 10. The first cylindrical lens 63 parallelizes the light beams L incident thereon in the YZ plane.

The first lens array 64 has a plurality of first cylindrical lenses 67. The first cylindrical lenses 67 correspond to respective light beams L outputted from the first light source unit 15, as shown in FIG. 9. The first cylindrical lenses 67 are arranged in the X-axis direction. Each of the first cylindrical lenses 67 has curvature in the plan view. Each of the first cylindrical lenses 67 has no curvature in the side view viewed in the X-axis direction, as shown in FIG. 10. The first cylindrical lenses 67 cause the light beams L incident thereon to converge in the plane (XY plane) parallel to both the direction in which the first cylindrical lenses 67 are arranged and the direction of the chief rays of the light beams L (Y-axis direction).

The second cylindrical lens 65 is so provided as to be common to the plurality of light emitting devices 25 that form the second light source unit 16, as shown in FIG. 9. The plurality of light beams L emitted from the plurality of light emitting devices 25 enters the second cylindrical lens 65. The second cylindrical lens 65 has no curvature in the plan view. The second cylindrical lens 65 has curvature in the side view viewed in the Y-axis direction. The second cylindrical lens 65 parallelizes the light beams L incident thereon in the XZ plane.

The second lens array 66 has a plurality of second cylindrical lenses 68. The second cylindrical lenses 68 correspond to respective light beams L outputted from the second light source unit 16. The second cylindrical lenses 68 are arranged in the Y-axis direction. Each of the second cylindrical lenses 68 has curvature in the plan view. Each of the second cylindrical lenses 68 has no curvature in the side view viewed in the Y-axis direction. The second cylindrical lenses 68 cause the light beams L incident thereon to converge in the plane (XY plane) parallel to both the direction in which the second cylindrical lenses 68 are arranged and the direction of the chief rays of the light beams L (X-axis direction).

The other configurations are the same as those in the first embodiment.

The second embodiment also provides the same advantageous effect of the first embodiment, that is, a first light source apparatus 61 that allows reduction in light loss while controlling an increase in the size of the apparatus can be achieved.

### Third Embodiment

A third embodiment of the invention will be described below with reference to FIG. 11.

FIG. 11 is a plan view of key parts of the first light source apparatus of the third embodiment.

The basic configuration of the first light source apparatus of the third embodiment is the same as that in the first embodiment, but the configurations of the members downstream of the first collimation system differ from those in the first embodiment. The same portions as those in the first embodiment will therefore not be illustrated in FIG. 11.

In FIG. 11, the same components as those in FIG. 2 used in the first embodiment have the same reference characters and will not be described.

A first light source apparatus 101 of the third embodiment includes the light source unit 15, the second light source unit 16, the first light beam conversion system 17, the first light ray combiner 18, the first collimation system 70, a third light source unit 102, a fourth light source unit 103, a third light beam conversion system 104, a second light ray combiner 105, a second collimation system 106, a retardation film 107, and a polarization separation element 108, as shown in FIG. 11. The first light beam conversion system 17 includes the first lens array 21 and the second lens array 22. The third light beam conversion system 104 includes a third lens array 111 and a fourth lens array 112.

That is, the first light source apparatus 101 of the third embodiment includes two sets of light source sections each having the same configuration of the first light source apparatus 11 of the first embodiment, which is formed of the first light source unit 15, the second light source unit 16, the light beam conversion system 17, and the light ray combiner 18. A first light source section 115, which is formed of the first light source unit 15, the second light source unit 16, the first light beam conversion system 17, and the first light ray combiner 18, and a second light source section 116, which is formed of the third light source unit 102, the fourth light source unit 103, the third light beam conversion system 104, and the second light ray combiner 105, have the same configuration except that the first light source section 115 is different from the second light source section 116 in the arrangement of the constituent elements and in the light traveling direction.

In the first light source section 115, the light ray combiner 18 transmits the first light ray flux LT1 outputted from the first light source unit 15 whereas reflecting the second light ray flux LT2 outputted from the second light source unit 16, thereby producing a combined light ray flux LT5. Similarly, in the second light source section 116, the second light ray combiner 105 reflects the first light ray flux LT1 outputted from the third light source unit 102 whereas transmitting the second light ray flux LT2 outputted from the fourth light source unit 103, thereby producing a combined light ray flux LT6. The first light source section 115 and the second light source section 116 are so disposed that the direction along which the light ray flux LT5 exits the first collimation system 70 and the direction along which the light ray flux LT6 exits the second collimation system 106 form an angle of 90°.

The retardation film 107 is provided between the second light source section 116 and the polarization separation element 108. The retardation film 107 is formed, for example, of a half-wave plate. On the other hand, no retardation film is provided between the first light source section 115 and the polarization separation element 108. Therefore, even if the light beams L outputted from the light source units all have the same polarization direction, the polarization direction of the light beams L entering the polarization separation element 108 from the first light source section 115 differs from the polarization direction of the light beams L entering the polarization separation element 108 from the second light source section 116 via the retardation film 107. Instead, the retardation film 107 may be provided between the first light source section 115 and the polarization separation element 108, but no retardation film 107 may be provided between the second light source section 116 and the polarization separation element 108.

In the third embodiment, the light beams L outputted from the light source units are all P-polarized light with respect to the polarization separation element 108. In this case, the light ray flux LT5 is incident as P-polarized light on the polarization separation element 108. On the other hand, the light ray flux LT6, which passes through the retardation film 107, is incident as S-polarized light on the polarization separation element 108. The polarization separation element 108 transmits the P-polarized light ray flux LT5 whereas reflecting the S-polarized light ray flux LT6, thereby combining the light ray flux LT5 and the light ray flux LT6 with each other.

The third embodiment also provides the same advantageous effect of the first embodiment, that is, a first light source apparatus 101 that allows reduction in light loss while controlling an increase in the size of that apparatus can be achieved. Further, the first light source apparatus 101 of the third embodiment, which includes the first to fourth light source units, can increase the intensity of the combined light ray flux.

The polarization direction of the light beams L outputted from the first light source section 115 may be so set as to differ from the polarization direction of the light beams L outputted from the second light source section 116. For example, the polarization direction of the light beams L outputted from the first light source section 115 may be set to be P-polarized light with respect to the polarization separation element 108, and the polarization direction of the light beams L outputted from the second light source section 116 may be set to be S-polarized light with respect to the polarization separation element 108. Rotating one of the first light source section 115 and the second light source section 116 illustrated in FIG. 11 by 90° around the center axis of the light ray flux outputted therefrom allows the first light source section 115 and the second light source section 116 to differ from each other in the polarization direction of the light ray fluxes outputted therefrom. According to the configuration described above, no retardation film 107 is required.

### Fourth Embodiment

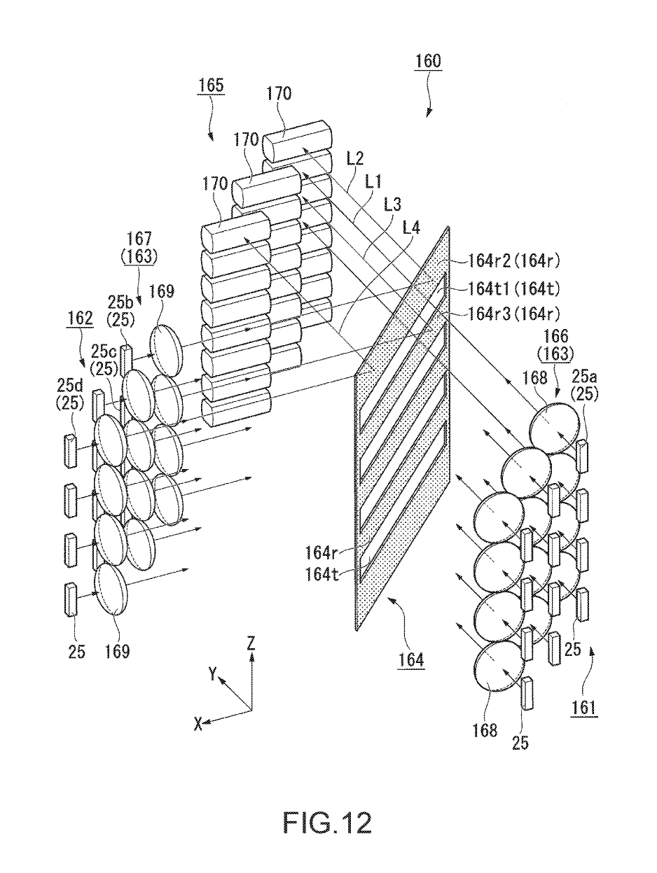

A fourth embodiment of the invention will be described below with reference to FIGS. 12 to 15.

The basic configuration of the first light source apparatus of the fourth embodiment is roughly the same as that in the first embodiment, and the configurations of members downstream of the dichroic mirror 80 are the same as those in the first embodiment. The members downstream of the dichroic mirror 80 are therefore omitted in FIGS. 12 to 15.

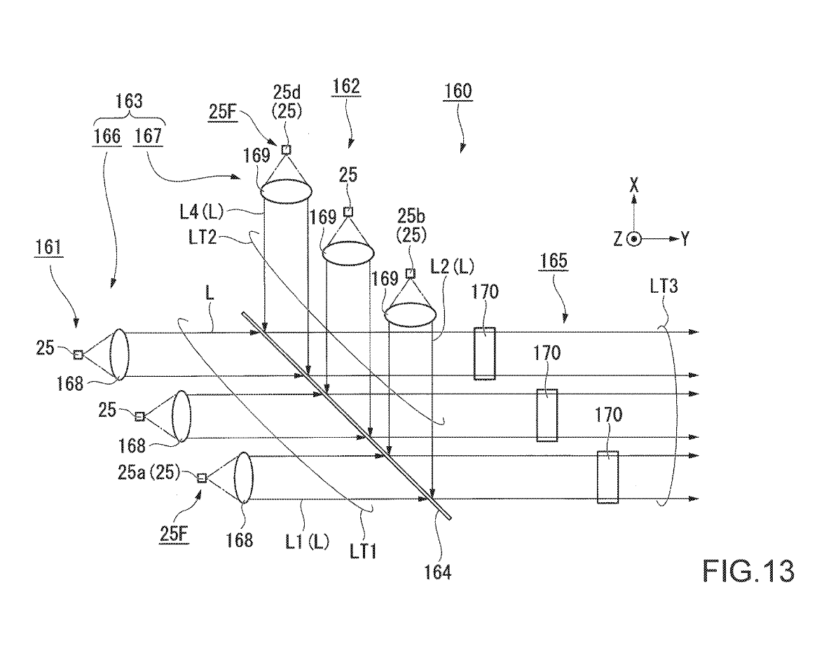

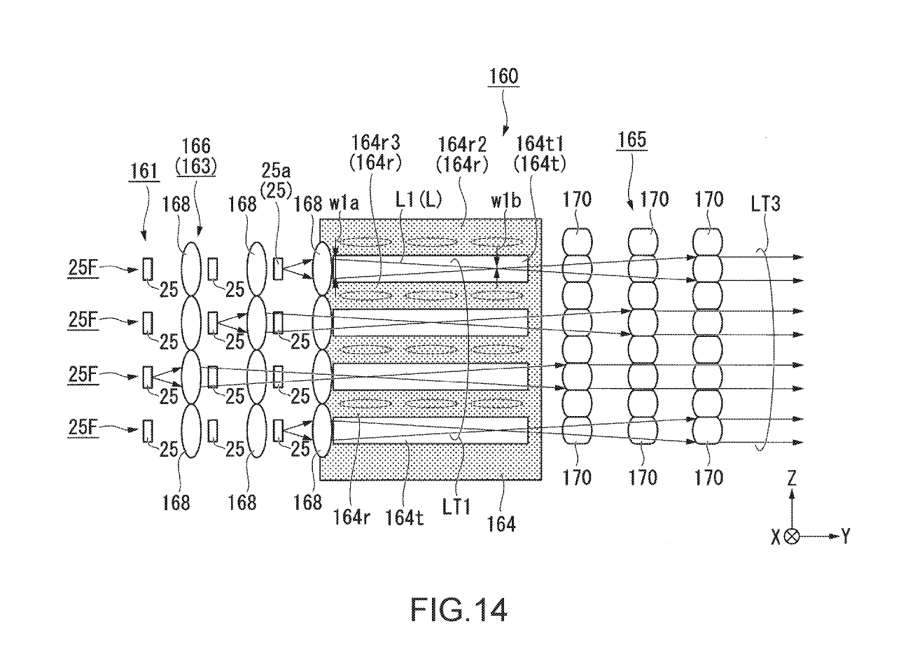

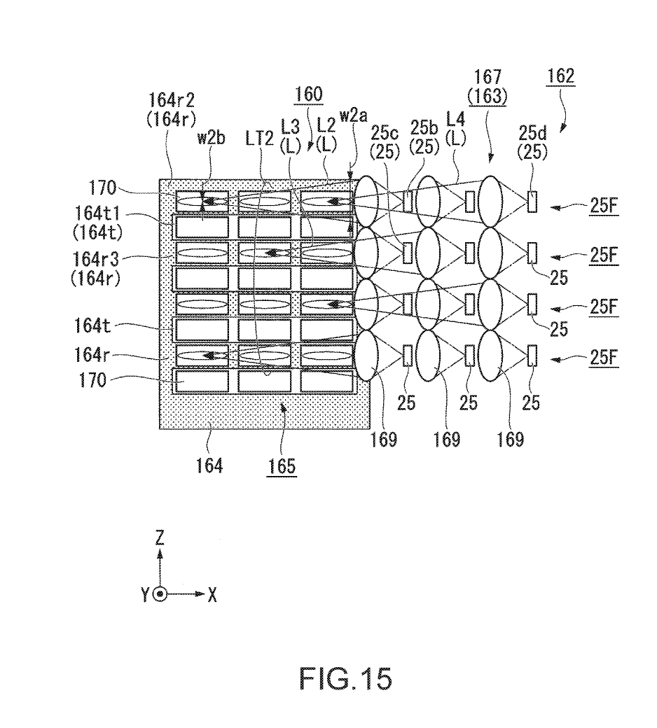

FIG. 12 is a perspective view of the first light source apparatus of the fourth embodiment. FIG. 13 is a plan view of the first light source apparatus. FIG. 14 is a side view of the first light source apparatus viewed in the second direction (X-axis direction). FIG. 15 is a side view of the first light source apparatus viewed in the first direction (Y-axis direction).

In FIGS. 12 to 15, the same components as those in FIG. 2 used in the first embodiment have the same reference characters and will not be described.

A first light source apparatus 160 includes a first light source unit 161, a second light source unit 162, a first light beam conversion system 163, a light ray combiner 164, a first collimation system 165, the dichroic mirror 80 (see FIG. 2), the first light collection system 90 (see FIG. 2), and the rotating phosphor plate 30 (see FIG. 2), as shown in FIGS. 12 to 15. The first light beam conversion system 163 includes a first lens array 166 corresponding to the first light source unit 161 and a second lens array 167 corresponding to the second light source unit 162.

The first light collimation system 165 of the present embodiment corresponds to the second light beam conversion system in the appended claims.

The first light source unit 161 includes a plurality of light emitting devices 25 including the first light emitting device 25a that emits the first light beam L1, as shown in FIG. 14. The light emitting devices 25 are so provided as to form a plurality of light source trains 25F arranged in the Z-axis direction. In the present embodiment, the light emitting devices 25 form four light source trains 25F arranged in the Z-axis direction. Each of the light source trains 25F is formed of three light emitting devices 25. The three light emitting devices 25 that form one light source train 25F are disposed in different positions in the X-axis direction (second direction) and the Y-axis direction (first direction), as shown in FIG. 13. The first light source unit 161 outputs the first light ray flux LT1 in the Y-axis direction (first direction). The first light ray flux LT1 is formed of a plurality of light beams L including the first light beam L1. The Z-axis direction corresponds to the third direction, as will be described later.

The second light source unit 162 includes a plurality of light emitting devices 25 including the second light emitting device 25b, which emits the second light beam L2, and the third light emitting device 25c, which emits the third light beam L3, as shown in FIG. 15. The light emitting devices 25 are so provided as to form a plurality of light source trains 25F arranged in the Z-axis direction. In the present embodiment, the light emitting devices 25 form four light source trains 25F arranged in the Z-axis direction. Each of the light source trains 25F is formed of three light emitting devices 25. The three light emitting devices 25 that form one light source train 25F are disposed in different positions in the X-axis direction (second direction) and the Y-axis direction (first direction), as shown in FIG. 13. The second light source apparatus 162 outputs the second light ray flux LT2 in the X-axis direction (second direction). The second light ray flux LT2 is formed of a plurality of light beams L including the second light beam L2 and third light beam L3. The plurality of light emitting devices 25 that form the first light source unit 161 and the second light source unit 162 are mounted on a substrate that is not shown.

As the second light emitting device 25b and the third light emitting device 25c, two light emitting devices 25 adjacent to each other in the Z-axis direction are selected from the twelve light emitting devices 25 of the second light source unit 162, as shown in FIG. 15. In the present embodiment, the light emitting device 25 located at the left end of the top light source train 25F in FIG. 15 is set to be the second light emitting device 25b, and the light emitting device 25 located at the left end of the second light source train 25F counted from the top is set to be the third light emitting device 25c. Further, as shown in FIG. 12, as the first light emitting device 25a, the light emitting device 25 that emits the light beam L located between the second light beam L2 and the third light beam L3 in the light ray combiner 164 is selected. Therefore, in the present embodiment, as the first light emitting device 25a, the light emitting device 25 located at the right end of the top light source train in FIG. 14 is selected from the twelve light emitting devices 25 of the first light source unit 161 shown in FIG. 14.

Further, in the second light source unit 162, in the light source train 25F including the second light emitting device 25b, the light emitting device 25 disposed in a position different in the X-axis direction (second direction) and the Y-axis direction (first direction) from the position of the second light emitting device 25b is set to be a fourth light emitting device 25d, as shown in FIG. 15. The fourth light emitting device 25d emits a fourth light beam L4.

The first lens array 166 includes first lenses 168 corresponding to respective light beams L emitted from the plurality of light emitting devices 25 of the first light source unit 161. The first lenses 168 are all formed of anamorphic lenses having the same refractive power. The first lenses 168 cause the light beams L incident thereon to converge in the plane (YZ plane) parallel to both the Z-axis direction and the direction of the chief rays of the light beams L (Y-axis direction), as shown in FIG. 14. Further, the first lenses 168 parallelize the light beams L incident thereon in the XY plane, as shown in FIG. 13.

The second lens array 167 includes second lenses 169 corresponding to respective light beams L emitted from the plurality of light emitting devices 25 of the second light source unit 162. The second lenses 169 are all formed of anamorphic lenses having the same refractive power. The second lenses 169 cause the light beams L incident thereon to converge in the plane (XZ plane) parallel to both the Z-axis direction and the direction of the chief rays of the light beams L (X-axis direction), as shown in FIG. 15. Further, the second lenses 169 parallelize the light beams L incident thereon in the XY plane, as shown in FIG. 13.

The light ray combiner 164 has a plurality of reflective areas 164r and a plurality of light transmissive areas 164t, as shown in FIG. 12. The configuration of the reflective areas 164r and the configuration of the light transmissive areas 164t are the same as those in the first embodiment, but the arrangement of the reflective areas 164r and the light transmissive areas 164t differs from the arrangement in the first embodiment. In the present embodiment, when the light ray combiner 164 is viewed in the direction perpendicular to the Z-axis direction, the reflective areas 164r and the light transmissive areas 164t are alternately disposed.

The reflective area 164r on which the second light beam L2 and the fourth light beam L4 are incident is called a second area 164r2, and the reflective area 164r on which the third light beam L3 is incident is called a third area 164r3. The light transmissive area 164t which is located between the second area 164r2 and the third area 164r3 and on which the first light beam L1 is incident is called a first area 164t1. Further, the direction in which the second area 164r2 and the third area 164r3 are arranged is called a third direction. In the present example, the third direction is the Z-axis direction, which is perpendicular to the X-axis direction (second direction) and the Y-axis direction (first direction). The fourth light beam L4 is incident on the second area 164r2, on which the second light beam L2 is incident, as described above. The second area 164r2 in the present embodiment therefore corresponds to the second area in the appended claims and also corresponds to the fourth area in the appended claims.

The first light beam conversion system 163 converts each of the specific light beams into a convergent light beam in such a way that the dimension of the specific light beam in the third direction (Z-axis direction) at a stage in which the specific light beam enters the light ray combiner 164 is smaller than the dimension of the specific light beam in the third direction (Z-axis direction) at a stage in which the specific light beam exits the first light beam conversion system 163, as shown in FIGS. 14 and 15.

Specifically, the first lens 168 of the first light beam conversion system 163 converts the first light beam L1 into a convergent light beam in such a way that the dimension w1b of the first light beam L1 in the third direction (Z-axis direction) at a stage in which the first light beam L1 enters the light ray combiner 164 is smaller than the dimension w1a of the first light beam L1 in the third direction (Z-axis direction) at a stage in which the first light beam L1 exits the first light beam conversion system 163, as shown in FIG. 14.

The second lens 169 of the first light beam conversion system 163 converts the second light beam L2 into a convergent light beam in such a way that the dimension w2b of the second light beam L2 in the third direction (Z-axis direction) at a stage in which the second light beam L2 enters the light ray combiner 164 is smaller than the dimension w2a of the second light beam L2 in the third direction (Z-axis direction) at a stage in which the second light beam L2 exits the first light beam conversion system 163, as shown in FIG. 15. The third light beam L3 is converted into a convergent light beam in the same manner in which the second light beam L2 is converted.

The first collimation system 165 is provided in a position downstream of the light ray combiner 164. The first collimation system 165 is formed of cylindrical lenses 170. The cylindrical lenses 170 are so provided as to correspond to the respective light beams L that form the combined light ray flux. In the present embodiment, twelve light beams L emitted from the twelve light emitting devices 25 of the first light source unit 161 and twelve light beams L emitted from the twelve light emitting devices 25 of the second light source unit 162 are combined with each other to form the combined light ray flux LT3. The first collimation system 165 is therefore formed of twenty four cylindrical lenses 170, as shown in FIGS. 14 and 15.

Each of the cylindrical lenses 170 is so disposed that the generatrix thereof extends in the X-axis direction, as shown in FIGS. 12 and 13. Each of the cylindrical lenses 170 therefore has no refractive power in the XY plane but has refractive power in the YZ plane. The first collimation system 165 outputs each of the specific light beams in the form of parallelized light when viewed in a direction (X-axis direction) perpendicular to the Z axis.

The light ray combiner 164 inclines by 45° with respect to both the X-axis direction and the Y-axis direction, as shown in FIG. 13. The three light emitting devices 25 that form each of the light source trains 25F of the first light source unit 161 are disposed in different positions in the Y-axis direction. A distance along the Y-axis direction between each of the three light emitting devices 25 and the light ray combiner 164, hence, has the same value.

Similarly, the three light emitting devices 25 that form each of the light source trains 25F of the second light source unit 162 are disposed in different positions in the X-axis direction. A distance along the X-axis direction between each of the three light emitting devices 25 and the light ray combiner 164, hence, has the same value. For example, in one of the light source trains 25F, the distance between the second light emitting device 25b and the light ray combiner 164 along the X-axis direction (second direction) is equal to the distance between the fourth light emitting device 25d and the light ray combiner 164 along the X-axis direction (second direction).

The first lenses 168 are all formed of anamorphic lenses having the same refractive power, and the light emitting devices 25 of the first light source unit 161 are separate from the light ray combiner 164 by the same distance, as described above. The light beams L emitted from all the light emitting devices 25 of the first light source unit 161 can therefore be readily focused on the light transmissive areas 164t of the light ray combiner 164, as shown in FIG. 14. In the present specification, however, the sentence “a light beam L focuses in a position” means that when viewed in the direction perpendicular to the Z axis, the dimension of the light beam L in the third direction is the smallest in that position among the dimensions of the light beam L in the third direction along the optical path between the first light beam conversion system 163 and the first collimation system 165.

Similarly, the second lenses 169 are all formed of anamorphic lenses having the same refractive power, and the light emitting devices 25 of the second light source unit 162 are separate from the light ray combiner 164 by the same distance. The light beams L emitted from all the light emitting devices 25 of the second light source unit 162 can therefore be readily focused on the light reflective areas 164r of the light ray combiner 164, as shown in FIG. 15.

That is, the light ray combiner 164 receives each light beam L in a position where the dimension of the light beam L in the third direction (Z-axis direction) is the smallest among those along the optical path between the first light beam conversion system 163 and the first collimation system 165. For example, the light ray combiner 164 receives the second light beam L2 in a position where the second light beam L2 is focused and receives the fourth light beam L4 in a position where the fourth light beam L4 is focused.

The divergence angle of each of the specific light beams in the plane perpendicular to the third direction (Z-axis direction) is greater than the divergence angle of the specific light beam in the plane containing both the chief ray of the specific light beam and the third direction. Each of the light emitting devices 25 is disposed in the focal point of the corresponding first lens 168 or the second lens 169, which is formed of an anamorphic lens, in the plane perpendicular to the third direction, as shown in FIG. 13. That is, the specific light beam is emitted at the focal point of the anamorphic lens in the plane perpendicular to the third direction. The configuration described above allows the anamorphic lens to parallelize the specific light beam when viewed in the third direction.

The fourth embodiment also provides the same advantageous effect of the first embodiment, that is, a first light source apparatus 160 that allows reduction in light loss while controlling an increase in the size of the apparatus can be achieved.

In the present embodiment, in particular, each of the plurality of light beams L outputted from the light source unit 161 is focused on the corresponding light transmissive area 164t, and each of the plurality of light beams L outputted from the light source unit 162 is focused on the corresponding reflective area 164r. The dimension of the first light source apparatus 160 in the Z-axis direction can therefore be further reduced while the light loss is sufficiently controlled.

For example, in the first light source unit 161, since the distance along the Y-axis direction between each light emitting device 25 and the light ray combiner 164 has the same value, the first light beam conversion system 163, which includes the first lenses 168 having the same refractive power, can readily achieve the configuration in which each light beam L is focused on the light ray combiner 164. The same holds true for the second light source unit 162.

Further, even in a case where the dimension of each of the light beams L incident on the light ray combiner 164 is smaller than the dimension of the corresponding light transmissive area 164t or reflective area 164r, variation in the positions where the light emitting devices 25 are mounted causes part of the light beam L that is supposed to pass through the light transmissive area 164t is reflected off a reflective area or part of the light beam L that is supposed to be reflected off the reflective area 164r passes through a light transmissive area 164t, resulting in light loss in some cases. To solve the problem, the first light source apparatus 160 of the present embodiment, in which each of the light beams L is incident on the light ray combiner 164 at a position where the dimension of the light beam L in the third direction is minimized, allows an increase in the margin of error in mounting the light emitting devices 25.

Further, since the first light source apparatus 160 includes the first collimation system 165, each of the light beams L, which is caused to converge before it enters the light ray combiner 164 and caused to diverge after it exits the light ray combiner 164, is parallelized by the first collimation system 165 when viewed in the X-axis direction. Light loss in the optical system downstream of the first collimation system 165 can therefore be reduced.

Further, since the first light beam conversion system 163 is formed of a plurality of anamorphic lenses, the configuration of the first light beam conversion system 163 can be simplified, and a specific light beam L can be caused to converge in a specific direction. Moreover, the dimension of the specific light beam in the Z-axis direction can be readily reduced, whereby the light loss can be reliably controlled.

In the first light source apparatus of any of the first to fourth embodiments described above, for example, the following light ray combiner can be used.

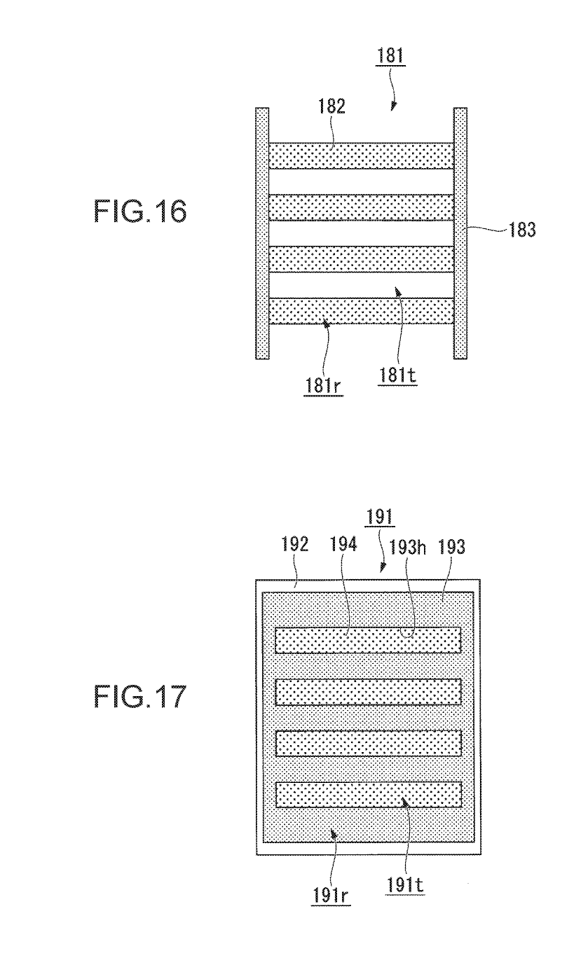

FIG. 16 is a front view showing a first example of the light ray combiner. FIG. 17 is a front view showing a second example of the light ray combiner.

A light ray combiner 181 of the first example includes a plurality of strip-shaped mirrors 182 and support members 183, as shown in FIG. 16. Each of the plurality of strip-shaped mirrors 182 is supported by the support members 183 at the opposite ends of the mirror 182. The strip-shaped mirrors 182 adjacent to each other are so disposed that a gap is present therebetween. The areas where the strip-shaped mirrors 182 are provided are reflective areas 181r, and the gap between the strip-shaped mirrors 182 adjacent to each other is a light transmissive area 181t.

A light ray combiner 191 of the second example includes a transparent substrate 192 and a reflection film 193 having a plurality of openings 193h formed therein, as shown in FIG. 17. An antireflection film 194 is provided in each of the openings 193h of the reflection film 193. The area where the reflection film 193 is provided is a reflective area 191r, and areas of the openings 193h of the reflection film 193 are light transmissive areas 191t.

The technical range of the invention is not limited to the embodiments described above, and a variety of changes can be made thereto to the extent that the changes do not depart from the substance of the invention.

### Variation 1

The light source apparatus of each of the embodiments described above includes the light beam conversion system that converts all light beams emitted from the plurality of light emitting devices of the first light source unit and all light beams emitted from the plurality of light emitting devices of the second light source unit into convergent light beams. In place of the configuration described above, the light source apparatus according to any of the embodiments of the invention may include a light beam conversion system including only one of the first lens array 21 and the second lens array 22.

For example, in a case where the light source apparatus includes only the first lens array 21, the second lens array 22 may be replaced with an optical system that parallelizes each of the plurality of light beams outputted from the second light source unit.

### Variation 2

The light beam conversion system may convert only part of the plurality of light beams emitted from the plurality of light emitting devices of one light source unit into convergent light beams. For example, a light beam conversion system that converts, among the first light beam emitted from the first light emitting device, the second light beam emitted from the second light emitting device, and the third light beam emitted from the third light emitting device, only the second light beam into a convergent light beam may be provided. According to the configuration described above, even if the pitch between the second light emitting device and the third light emitting device is small, the amount of blocking of the second light beam can be reduced, whereby a light source apparatus that allows light loss to be reduced and an increase in the size of the apparatus to be avoided can be achieved.

In Variations 1 and 2, since the combined light ray flux outputted from the light ray combiner includes a convergent light beam and a non-convergent light beam, it is difficult for the first collimation system to parallelize the combined light ray flux in a collective manner. Therefore, in a case where the convergent light beam is incident on the reflective area of the light ray combiner, it is preferable that the reflective surface of the reflective area has curvature that parallelizes the convergent beam. On the other hand, in a case where the convergent light beam is incident on the light transmissive area of the light ray combiner, it is preferable that refractive power is imparted to the member that form the light transmissive area to parallelize the convergent light beam. In the case where the light ray combiner parallelizes each of the convergent light beams as described above, the first collimation system can be omitted.

As another variation, the first light source unit may include at least one light emitting device, and the second light source unit may include at least two light emitting devices.

The light beam conversion system may be formed of an optical member other than a lens. For example, the light beam conversion system may be formed of concave mirrors corresponding to the respective light emitting devices.

The light beam conversion system may cause the light beams to converge not only in the shorter-side direction of the reflective areas or the light transmissive areas of the light ray combiner but also in the longitudinal direction thereof.

The second embodiment has been described with reference to the case where the light beam conversion system is formed of the combination of a single cylindrical lens and a cylindrical lens array. Instead, for example, the light beam conversion system may be formed of the combination of a collimator lens formed of a spherical lens or an aspherical lens and a cylindrical lens array.

A configuration in which the light transmissive areas transmits the second light ray flux, and the reflective areas reflects the first light ray flux may instead be employed.

The embodiments described above have been described with reference to a projector including three light modulators. The invention is also applicable to a projector that displays color video images by using one light modulator. Further, as the light modulators, the liquid crystal panels described above are not necessarily used, and a digital mirror device can, for example, be used.

In addition to the above, the shape, the number, the arrangement, the material, and other factors of the variety of components of the illuminator and the projector are not limited to those in the embodiments described above and can be changed as appropriate.

Further, the above embodiments have been described with reference to the case where the illuminator according to each of the embodiments of the invention is incorporated in a projector, but not necessarily. The light source apparatus according to any of the embodiments of the invention may be used as a lighting apparatus, a headlight of an automobile, and other components.

The entire disclosure of Japanese Patent Application No.: 2016-105354, filed on May 26, 2016 and 2017-026320, filed on Feb. 15, 2017 are expressly incorporated by reference herein.

What is claimed is:

1. A light source apparatus comprising:
a first light source unit for emitting a first light ray flux in a first direction, the first light source unit including a first light emitting device for emitting a first light beam, the first light ray flux containing the first light beam;
a second light source unit for emitting a second light ray flux in a second direction that interests the first direction, the second light source unit including a second light emitting device for emitting a second light beam and a third light emitting device for emitting a third light beam, the second light ray flux containing the second light beam and the third light beam;
a first light beam conversion system that changes a dimension of a specific light beam that is one of the first light beam, the second light beam, and the third light beam; and
a light ray combiner that is provided in a position downstream of the first light beam conversion system and reflects one of the first light ray flux and the second light ray flux to produce a combined light ray flux containing the first light ray flux and the second light ray flux,
wherein the light ray combiner has a second area on which the second light beam is incident, a third area on which the third light beam is incident, and a first area which is located between the second area and the third area and on which the first light beam is incident, and
the first light beam conversion system converts the specific light beam in such a way that a dimension of the specific light beam in a third direction, which is a direction in which the second area and the third area are arranged, at a stage in which the specific light beam enters the light ray combiner is smaller than the dimension of the specific light beam in the third direction at a stage in which the specific light beam exits the first light beam conversion system.

2. The light source apparatus according to claim 1,
wherein the third direction is a direction between the first direction and the second direction in a plan view viewed in a direction perpendicular to the first direction and the second direction,
the second light emitting device and the third light emitting device are disposed in positions different from each other in the first direction,
the first light beam conversion system converts the specific light beam into a convergent light beam that converges in the plan view, and outputs the converted light, and
in the plan view, in the combined light ray flux, the first light beam is positioned between the second light beam and the third light beam.

3. The light source apparatus according to claim 2, further comprising a second light beam conversion system that is provided on an optical path of the combined light ray flux and parallelizes the specific light beam in the plan view.

4. The light source apparatus according to claim 3,
wherein each of the first light beam, the second light beam, and the third light beam corresponds to the specific light beam, and
when the first light beam, the second light beam, and the third light beam enter the second light beam conversion system, a dimension of the first light beam in a direction in which the second light beam and the third light beam are arranged is smaller than a gap between the second light beam and the third light beam in the plan view.

5. The light source apparatus according to claim 3,
wherein the first light source unit includes light emitting devices that include the first light emitting device and are disposed in positions different from one another in the second direction,
the second light source unit includes light emitting devices that include the second light emitting device and the third light emitting device and are disposed in positions different from one another in the first direction,
the light ray combiner includes reflective areas and light transmissive areas, and
the reflective areas and the light transmissive areas are alternately disposed in the plan view.

6. The light source apparatus according to claim 5,
wherein the first light beam conversion system includes a first lens array having first lenses corresponding to light beams outputted from the first light source unit and a second lens array having second lenses corresponding to light beams outputted from the second light source unit,
the second light beam conversion system includes a collimator lens array having collimator lenses, and
in the plan view, a pitch of the collimator lenses is half a pitch of the light beams outputted from the first light source unit.

7. The light source apparatus according to claim 5,
wherein each of the light emitting devices of the first light source unit is formed of a laser diode having a light exiting area having a shorter-side direction that intersects the second direction, and
each of the light emitting devices of the second light source unit is formed of a laser diode having a light exiting area having a shorter side direction that intersects the first direction.

8. The light source apparatus according to claim 2, wherein the first light beam conversion system causes the specific light beam to converge in the plan view but parallelizes the specific light beam in a plane perpendicular to a plane containing the first direction and the second direction.

9. The light source apparatus according to claim 1,
wherein the third direction is perpendicular to the first direction and the second direction,
the first light emitting devices, the second light emitting device, and the third light emitting device are disposed in positions different from one another in the third direction, and
in the combined light ray flux, the first light beam is positioned between the second light beam and the third light beam when viewed in the first direction.

10. The light source apparatus according to claim 9,
wherein the first light source unit includes light emitting devices that include the first light emitting device and are disposed in positions different from one another in the third direction,
the second light source unit includes light emitting devices that include the second light emitting device and the third light emitting device and are disposed in positions different from one another in the third direction,
light beams from the light emitting devices of the first light source unit and the light emitting devices of the second light source unit each correspond to the specific light beam.

11. The light source apparatus according to claim 9,
further comprising a second light beam conversion system provided on an optical path of the combined light ray flux,
wherein the second light beam conversion system outputs the specific light beam as parallelized light when viewed in a direction perpendicular to the third direction.

12. The light source apparatus according to claim 11,
wherein the light emitting devices of the second light source unit are so provided as to form a plurality of light source trains arranged in the third direction,
among the plurality of light source trains, the light source train including the second light emitting device includes a fourth light emitting device that is disposed in a position different from the second light emitting device in the first direction and emits a fourth light beam,
the light ray combiner further has a fourth area on which the fourth light beam is incident, and
the light ray combiner is so provided as to receive the second light beam in a position where a dimension of the second light beam in the third direction is smallest among the dimensions thereof along an optical path of the second light beam between the first light beam conversion system and the second light beam conversion system and receive the fourth light beam in a position where a dimension of the fourth light beam in the third direction is smallest among the dimensions thereof along an optical path of the fourth light beam between the first light beam conversion system and the second light beam conversion system.

13. The light source apparatus according to claim 12, wherein a distance between the second light emitting device and the light ray combiner along the second direction is equal to a distance between the fourth light emitting device and the light ray combiner along the second direction.

14. The light source apparatus according to claim 9, wherein the first light beam conversion system includes an anamorphic lens on which the specific light beam is incident.

15. The light source apparatus according to claim 14,
wherein a divergence angle of the specific light beam in a plane perpendicular to the third direction is greater than a divergence angle of the specific light beam in a plane containing a chief ray of the specific light beam and the third direction,
the specific light beam is emitted from a focal point of the anamorphic lens in the plane perpendicular to the third direction, and
the anamorphic lens parallelizes the specific light beam when viewed in the third direction.

16. The light source apparatus according to claim 1, further comprising a phosphor layer that converts at least part of the combined light ray flux into fluorescence.

17. A projector comprising:
the light source apparatus according to claim 1;
a light modulator that modulates light outputted from the light source apparatus, in accordance with image information; and
a projection system that projects the light modulated with the light modulator.

18. A projector comprising:
the light source apparatus according to claim 2;
a light modulator that modulates light outputted from the light source apparatus, in accordance with image information; and
a projection system that projects the light modulated with the light modulator.

19. A projector comprising:
the light source apparatus according to claim 9;
a light modulator that modulates light outputted from the light source apparatus, in accordance with image information; and
a projection system that projects the light modulated with the light modulator.

20. A projector comprising:
the light source apparatus according to claim 10;
a light modulator that modulates light outputted from the light source apparatus, in accordance with image information; and
a projection system that projects the light modulated with the light modulator.
